(19) United States
(12) Patent Application Publication
(10) Pub. No.: US 2003/0190474 A1
(43) Pub. Date: Oct. 9, 2003

(54) High strength film ream wrap

(76) Inventors: Michael R. Nowak, Hilbert, WI (US); LouAnn S. Mueller, Little Chute, WI (US)

Correspondence Address: Philip M. Weiss, WEISS & WEISS PC, 500 Old Country Road, Suite 305, Garden City, NY, 11530, US

(21) Appl. No.: 10/117,625

(22) Filed: Apr. 5, 2002

(51) Int. Cl. B32B 27/36

(52) U.S. Cl. 428/403; 428/537.5; 156/244.11

(57) ABSTRACT

A high strength poly or polyester film ream wrapper and method of making the same.

### FILED OF THE INVENTION

The present invention relates to a high strength poly or polyester film ream wrapper and a method for producing the same.

### BACKGROUND OF THE INVENTION

Reams (i.e., 500 sheets) of cut paper (8½×11, etc.) for copy machines, computers, printers, and other applications are most commonly packaged for shipping, storage, and retail sale in ream wrappers made of various wrap materials. These wrap materials traditionally have been paper (poly coated or two papers laminated with poly), plastic film, or a paper/solid plastic film combination. In addition to encasing the reams of paper, the wrap materials protect the wrapped paper product from physical damage and moisture pickup during shipping and storage. The wrap materials also protect the wrapped product from physical damage during repeated handling and stocking on retail shelves.

As small offices and home offices have proliferated, the distribution of reams of paper has changed from boxes for large users to wrapped reams for retail stores and the small office and home office segments. Retail and in-store distribution of reams of paper has placed increasing demands on the wrapper due to rougher handling and more frequent re-stocking of the individual reams. Increased handling of the reams has resulted in more reams breaking open, damaging the wrapped paper product by allowing it to pick up moisture, tear, or get minor curl - physical damage that ultimately results in jams in the end-user's printer or copy machine. As a result, the market has demanded a stronger ream wrap.

As retail and store distribution of reamed papers has increased, the market also has demanded that manufacturers develop wrap materials with improved printing surfaces to enhance graphics and provide an eye-appealing wrapped product for the consumer. One such material is a solid plastic film ream wrap that provides a smooth, high gloss surface for printing. Film ream wraps may also be transparent so that the paper product encased in the wrapper is visible from the outside of the package.

Traditionally, film ream wraps have consisted of one heavy weight film layer or two separate layers of solid lighter weight plastic films laminated together with an adhesive. A major disadvantage of the current film ream wraps is that, once the consumer opens the side seal of the wrapped package to remove sheets of paper, the wrapper can readily and easily tear, exposing any paper remaining in the wrapper to physical damage, tearing and moisture. Film ream wraps also have been more vulnerable to physical damage during shipping, handling and storage than conventional ream wraps made of paper or paper/film combinations. In addition, film ream wraps have lacked the structural support of heavier weight paper laminates, coated papers, and paper/film composites, resulting in torn, unsightly packages on store and retail shelves. Thus, the market is demanding a stronger film ream wrap that provides an enhanced printing surface, less vulnerability to tearing and physical damage, and greater structural support for the wrapped product. The present invention provides these added benefits.

### SUMMARY OF THE INVENTION

The present invention relates to a high strength poly or polyester film ream wrapper. The product is made by using copolymer and/or terpolymer resins alone or blended with polyethylene, in the place of an adhesive, between two layers of solid plastic film. The copolymer and terpolymer resins are made by combining butene, hexene, and/or octene with ethylene in the feed stocks. It is an object of the present invention for the product to be produced by applying or extruding the copolymer and/or terpolymer between two sheets of solid plastic film.

The present invention relates to a high strength poly or polyester film ream wrapper comprising: two sheets of polypropylene, biaxially oriented polypropylene (BOPP) or polyester film laminated together with a layer of copolymer and/or terpolymer resins. The copolymer and/or terpolymer resins comprise butene, hexene, and/or octene with ethylene in feed stocks. The copolymer and/or terpolymer resins are applied or extruded between two sheets of solid plastic polypropylene, BOPP, or polyester film. This creates a product whereby two separate layers of polypropylene, BOPP, or polyester film are laminated together with a layer of copolymer and/or terpolymer resins or blend of copolymer/terpolymer resins with polyethylene in between the film layers.

The present invention also relates to a method for producing a high strength poly or polyester film ream wrapper comprising: applying or extruding copolymer and/or terpolymer resins between two sheets of solid plastic film or laminating two separate layers of solid plastic film with a copolymer and/or terpolymer resin. The present invention also relates to a method for producing a high strength poly or polyester film ream wrapper comprising: applying or extruding copolymer and/or terpolymer resins blended with polyethylene between two sheets of solid plastic film or laminating two separate layers of solid plastic film with a copolymer and/or terpolymer resin blended with polyethylene. This creates a film/copolymer and/or terpolymer resin/film combination or a film/copolymer and/or terpolymer resin blended with polyethylene film combination.

The present invention relates to a high strength poly or polyester film ream wrap material comprising; a first layer comprising a polypropylene, biaxially oriented polypropylene (BOPP) or polyester solid film. A second layer comprises a polypropylene, biaxially oriented polypropylene BOPP, or polyester solid film. A third layer comprises copolymer and/or terpolymer resins, alone, or blended with polyethylene. The third layer is interposed between the first layer and the second layer. It is an object of the present invention for the first layer and the second layer to have a thickness gauge between about 70 to about 120.

The present invention relates to a method of making a high strength poly or polyester film ream wrapper comprising; applying a copolymer and/or terpolymer layer to either of the solid plastic film layers, or applying a copolymer and/or terpolymer blended with polyethylene layer to either of the solid plastic film layers. The layers are conveyed toward a pair of nip rollers. The film layers are directed into an adjacent, noncontact position with the copolymer and/or terpolymer resin layer on its respective opposite sides prior to passing through the nip rollers. The layers pass through the nip rollers, forming the poly or polyester film ream wrapper.

### BRIEF DESCRIPTION OF THE DRAWINGS

FIG. 1 is a cross-sectional view of the high strength ream wrapper according to the invention.

FIG. 2 is a schematic view of the method and apparatus for producing the high strength ream wrapper according to the invention.

### DETAILED DESCRIPTION OF THE DRAWINGS

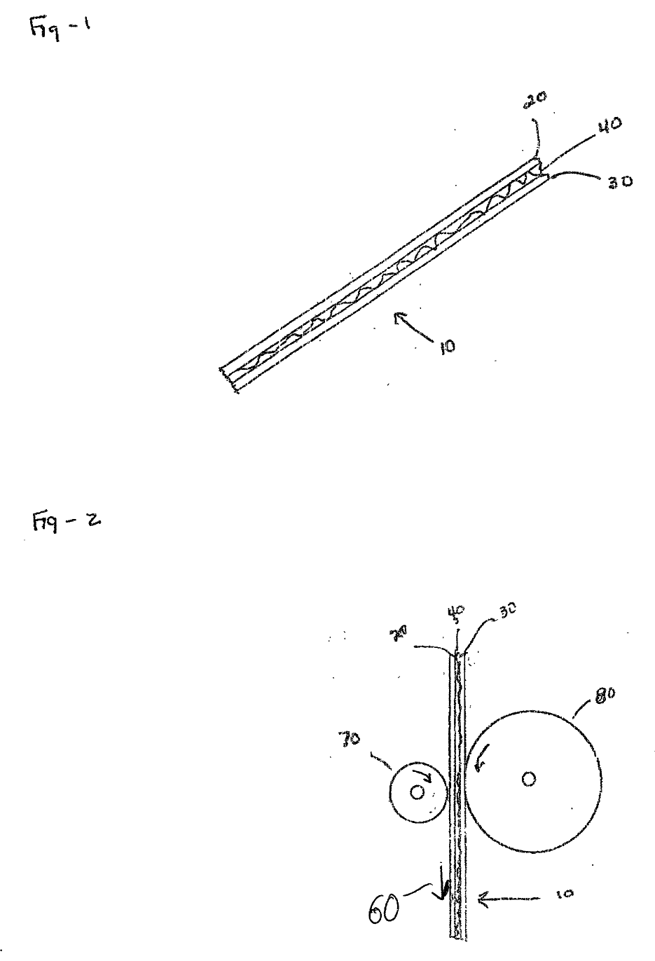

FIG. 1 shows an embodiment of the high strength film ream wrap material of the present invention. The high strength film ream wrap material 10 is made of a first layer 20 comprising a polypropylene, biaxially oriented polypropylene (BOPP) or polyester solid film. A second layer 30 also comprises a polypropylene, BOPP, or polyester solid film. A third layer 40 comprises copolymer and/or terpolymer resins, alone, or blended with polyethylene, interposed according to the invention between the first layer 20 and the second layer 30.

The first layer 20 and second layer 30 of the high strength film ream wrap material 10 can be made of either polypropylene, biaxially oriented polypropylene (BOPP), or polyester solid film of a thickness gauge between 70 to 120.

The third layer 40 of the high strength film ream wrap material 10 can be made of copolymer and/or terpolymer resins produced by combining butene, hexene, and/or octene with ethylene feedstock, alone, or in combination with polyethylene.

In a further embodiment, the lamination process for making the high strength film ream wrap 10 is schematically shown in FIG. 2. The copolymer and/or terpolymer layer 40 is applied to either of the solid plastic film layers 20 or 30 and is conveyed toward a pair of nip rollers 70 and 80 by any known method. The film layers 20 and 30 are directed by any well known means into an adjacent, noncontact position with the copolymer and/or terpolymer resin layer 40 on its respective opposite sides prior to passing through the nip rollers 70 and 80. The nip rollers, 70 and 80 rotate in opposite directions. As the layers, 20, 30 and 40 pass through the nip roller, 70, 80 in the direction of arrow 60, the three layers contact for the first time as they pass through the nip rollers to form a three-layered material 10.

1. A method of making a high strength poly or polyester film ream wrapper comprising;
applying a layer of a copolymer and/or terpolymer resins alone or blended with polyethylene between two layers of solid plastic film.

2. The method of claim 1 wherein said copolymer and/or terpolymer resins are made by combining butene, hexene, and/or octene with ethylene in feed stocks.

3. The method of claim 1 wherein said copolymer and/or terpolymer resins are extruded between said two layers of solid plastic film.

4. The method of claim 1 wherein said two layers of solid plastic film are laminated with said copolymer and/or terpolymer resins.

5. The method of claim 1 wherein said solid plastic film comprises;
polypropylene, biaxially oriented polypropylene (BOPP) or polyester.

6. A high strength poly or polyester film ream wrapper comprising:
two sheets of polypropylene, biaxially oriented polypropylene (BOPP) or polyester solid film laminated together with a layer of copolymer and/or terpolymer resins, alone or blended with polyethylene.

7. The poly film ream wrapper of claim 6 wherein said copolymer and/or terpolymer resins comprise butene, hexene, and/or octene with ethylene in feed stocks.

8. A high strength poly or polyester film ream wrap material comprising;
a first layer comprising a polypropylene, biaxially oriented polypropylene (BOPP) or polyester solid film,
a second layer comprising a polypropylene, biaxially oriented polypropylene BOPP, or polyester solid film; and
a third layer comprising copolymer and/or terpolymer resins, alone, or blended with polyethylene,
said third layer interposed between said first layer and said second layer.

9. The poly film ream wrap of claim 8 wherein said first layer and said second layer has a thickness gauge between 70 to 120.

10. The poly film ream wrap of claim 8 wherein said copolymer and/or terpolymer resins are produced by combining butene, hexene, and/or octene with ethylene feedstock, alone, or in combination with polyethylene.

11. A method of making a high strength poly or polyester film ream wrapper comprising;
applying a copolymer and/or terpolymer layer to either of solid plastic film layers; conveying said layers toward a pair of nip rollers;
directing said film layers into an adjacent, noncontact position with said copolymer and/or terpolymer resin layer on its respective opposite sides prior to passing through said nip rolls;
passing said layers through said nip rollers;
forming said poly film ream wrapper.
